(19) United States
(12) Patent Application Publication
(10) Pub. No.: US 2024/0218541 A1
(43) Pub. Date: Jul. 4, 2024

(54) ION-CONDUCTING MEMBRANE AND METHOD FOR PRODUCING SUCH A MEMBRANE

(71) Applicant: GEN-HY CUBE, Orly Aerogare (FR)

(72) Inventor: Arash Mofakhami, Buthiers (FR)

(21) Appl. No.: 18/559,042

(22) PCT Filed: May 27, 2021
(86) PCT No.: PCT/IB2021/054663

§ 371 Date: Nov. 4, 2023

(30) Foreign Application Priority Data
May 4, 2021 (FR) FR2104716

(51) Int. Cl. C25B 13/07; C25B 1/04; C25B 9/19; C25B 13/08

(52) U.S. Cl. CPC C25B 13/07; C25B 1/04; C25B 9/19; C25B 13/08

(57) ABSTRACT

An ion-conducting membrane, for an electrochemical device, includes a layer of a material comprising a ceramic. The ceramic comprises boron carbide (B4C). Also disclosed are a method for producing a membrane and a cell for an electrochemical device. The disclosed membrane, methods, and cells may have application to the electrolysis of water.

### CROSS-REFERENCE TO RELATED APPLICATIONS

This application is a national phase entry under 35 U.S.C. § 371 of International Patent Application PCT/IB2021/054663, filed May 27, 2021, designating the United States of America and published as International Patent Publication WO 2022/234327 A1 on Nov. 10, 2022, which claims the benefit, under Article 8 of the Patent Cooperation Treaty, of French Patent Application Serial No. FR2104716, filed May 4, 2021.

### TECHNICAL FIELD

The disclosure relates to ion-conducting membranes such as those used, in particular, but not exclusively, in electrolyzers.

### BACKGROUND

Document D1=FR2916906 describes various types of ceramic-based membranes, in particular membranes comprising boron nitride. When used for the electrolysis of water, such membranes participate in the activation of chemical reactions and make it possible to obtain purer hydrogen and oxygen gases.

### BRIEF SUMMARY

Embodiments of the disclosure provide a novel membrane having improved ion conduction properties and improved chemical, mechanical, and conductive characteristics compared to the membranes described in document D1.

More particularly, the disclosure proposes an ion-conducting membrane for an electrochemical device, the membrane comprising a layer of a material comprising a ceramic, wherein the ceramic comprises boron carbide (B4C).

Boron carbide is a ceramic that possesses multipolar molecular linkages and thus makes it possible to produce a membrane having good conductivity. The membrane comprising boron carbide also has relatively high chemical resistance, especially in basic media. The durability of the membrane is improved, achieving a service life of the order of 4 to 5 years in corrosive media (for example, in potassium hydroxide), as per current requirements for water electrolysis applications in alkaline media in particular. In addition, for water electrolysis applications with a membrane comprising boron carbide, the phenomenon of H2 gas dissolved in water passing through the membrane (phenomenon known as “crossover”) is less than with known membranes, making it possible to obtain purer gases.

The material preferably comprises:
60% to 95% by weight of pulverulent ceramic, ceramic comprising boron carbide, and
5% to 40% by weight of a polymer binder.

The polymer binder provides the binding between the particles of the ceramic powder. The binder also makes it possible to obtain a membrane impermeable to gases, in particular to hydrogen. The phenomenon of “crossover” is further attenuated.

The disclosure also relates to a process for producing a membrane and to an electrochemical cell comprising a membrane as described above.

Lastly, the disclosure relates to a water electrolysis plant comprising at least one electrochemical cell as described above.

### BRIEF DESCRIPTION OF THE DRAWINGS

Embodiments of the disclosure will be better understood, and other features and advantages of embodiments of the disclosure will become apparent, in the light of the following description of examples of implementation of the disclosure. These examples are non-limiting. The description should be read with reference to the accompanying drawings, in which:

FIG. 1 shows a cell suitable for a water electrolysis application; and

FIG. 2 shows a simplified diagram of a water electrolyzer.

### DETAILED DESCRIPTION

As stated above, the disclosure relates to an ion-conducting membrane for an electrochemical device, the membrane comprising a layer of a material comprising a ceramic, wherein the ceramic comprises boron carbide (B4C).

The material preferably comprises:
60% to 95% by weight of pulverulent ceramic comprising boron carbide, and
5% to 40% by weight of a polymer binder.

The ceramic powder may be pure boron carbide powder. The ceramic powder may also be a mixture of boron carbide powder and boron nitride powder. The presence of boron nitride makes it possible to improve the membrane production process, because boron nitride has a greater affinity for binding with the polymer binders. Boron nitride is in addition a dry lubricant that makes the membrane easier to use and can give it greater mechanical flexibility. However, to preserve the chemical properties and performance over time of boron carbide membranes, the boron nitride must be limited. Thus, for the membranes produced from a powder mixture, the most effective membranes were obtained for an amount of boron carbide greater by weight than the amount of boron nitride.

The polymer binder used may be:
a polytetrafluoroethylene (PTFE), or
a polyethersulfone (PES), or
a polyethersulfone derivative such as a sulfonated polyethersulfone (SPES) or an aminated-chlorinated polyethersulfone (PES-Cl-NH2), or
a mixture of polytetrafluoroethylene (PTFE), polyethersulfone (PES) and/or a polyethersulfone derivative.

With a polymer binder of the polytetrafluoroethylene (PTFE) type, the best results were obtained with an amount of binder of between 5% and 25% by weight (of the finished material). PTFE is chosen for its exceptional resistance to strongly oxidizing agents such as pure oxygen under pressure.

With a polymer binder of the polyethersulfone (PES) type, of the polyethersulfone derivative type, such as a sulfonated polyethersulfone (SPES) or an aminated-chlorinated polyethersulfone (PES-Cl-NH2), or a polymer mixture comprising polytetrafluoroethylene (PTFE), polyethersulfone (PES) and/or a polyethersulfone derivative, the best results were obtained with an amount of binder of between 15% and 40% by weight (of the finished material). PES and its derivatives are chosen for their better suitability for large-scale membrane production processes. To produce a membrane as described above, a process according to embodiments of the the disclosure comprises essentially the following steps:
a step of activating by dispersing an amount of ceramic powder in a basic solution, for example, a solution of potassium hydroxide KOH, and
a step of adding to the solution a binder polymer, in an amount of between 5% and 40% by weight.

During the activation step, the solution is stirred for 1 hour to 24 hours. The step of activating by dipping in a basic solution makes it possible to eliminate contaminating molecular linkages on the pendent linkages of the molecules of the ceramic powder particles. The use of a basic medium makes it possible to obtain a membrane that is more chemically resistant, thus with a longer duration of use for the membrane that more readily meets current resistance requirements of 4 to 5 years in corrosive media for applications such as water hydrolysis.

The addition of the binder polymer makes it possible to bind the powder particles to form a membrane without open pores that is impermeable to H2 gas dissolved in the water of the electrolyte.

Depending on the polymer binder used and the amount of binder used, the polymer binder can be mixed by stirring for a period of a few minutes to a few hours. In addition, mixing may be carried out under an atmosphere temperate-controlled at around 40° to 60° to facilitate mixing.

The process may also include a step of shaping the mixture.

According to one embodiment, in the case of a mixture comprising PES, in particular, the shaping step may comprise a step of casting the mixture onto a support, for example a glass plate. If necessary to facilitate casting, the casting step may be preceded by a step of adding a solvent such as water or ethanol in order to adjust the viscosity of the mixture and make the mixture sufficiently liquid to allow casting. The shaping step may then be followed by a drying step to remove the solvent and form the polymer network (crosslinking). This embodiment is particularly suitable for large-scale membrane production.

According to another embodiment, in the case of a mixture comprising PTFE in particular, the shaping step may comprise one or more lamination steps, each lamination step comprising a rolling step and a folding step carried out successively. The lamination step(s) make it possible to fold and connect the long carbon chains of the PTFE polymer binder so as to form a network within which ceramic powder particles are trapped. Depending on the consistency of the mixture, the lamination step(s) may be preceded by a filtering step and/or a drying step so as to obtain a paste that is pliable but not liquid.

According to yet another embodiment, the step of shaping the mixture may comprise a step of hot extrusion of the mixture, at a temperature of the order of 120° to 180°, preferably 150°. If necessary, the extrusion step may be followed by a lamination step.

Lastly, particularly if a flat membrane is desired, the process may include a final rolling step.

By way of example, the membranes used in water electrolysis plants generally have a thickness of the order of 0.2 mm to 0.4 mm.

The membrane according to embodiments of the the disclosure as described above can be used to produce an electrochemical cell comprising, in particular:
an anode 30
a cathode 20, and
between the anode and the cathode, a membrane 10 as described above.

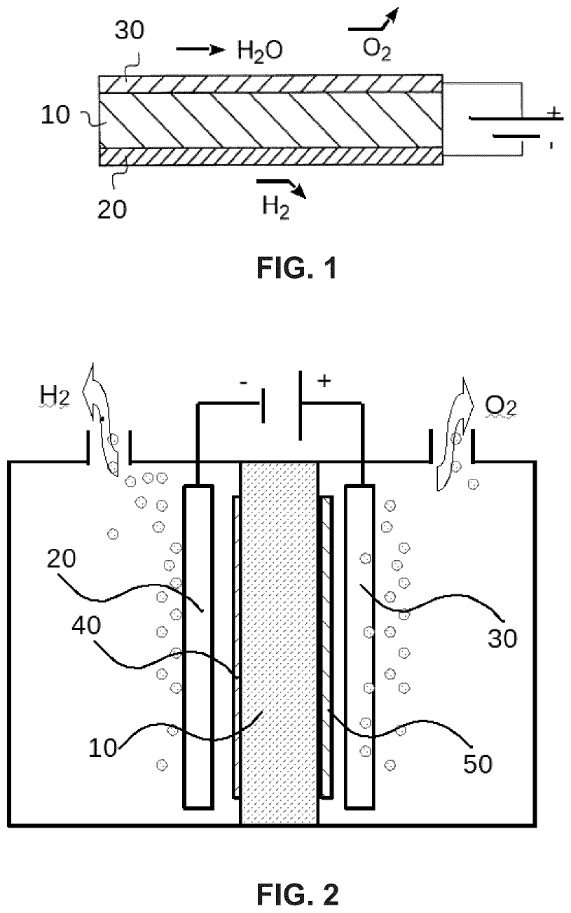

FIG. 1 shows a diagram of a known cell for a water electrolysis plant for producing gaseous hydrogen H2 and oxygen O2. FIG. 2 shows a diagram of the principle of a membrane water electrolysis plant. The membrane 10 divides a bath in two, the bath comprising a mixture of water and electrolyte. The cathode 20 and the anode 30 are positioned on either side of the membrane and are respectively connected to the negative and positive terminals of an electric power source. The membrane 10 permits good separation of the hydrogen gas produced at the cathode and the oxygen gas produced at the anode. The cathode and the anode are metallic, for example nickel, stainless steel or metal oxides, especially on the anode side. Nickel and stainless steel form oxides on their surface that are catalysts for the liberation of oxygen. 316L stainless steel is particularly effective by virtue of its molybdenum content.

In addition, to improve the chemical reactions, catalyst layers 40 and 50 may be deposited on the two sides of the membrane, between the cathode and the membrane on one side, and between the anode and the membrane on the other side. In addition, layers of catalyst may be deposited on the anode and/or on the cathode. The catalyst layers may comprise nickel powder. The catalyst materials used may in addition be different for the membrane and for the electrodes.

A single cell is depicted in FIG. 1. However, an industrial plant may in practice comprise a multiplicity of cells, or even around a hundred cells.

1. An ion-conducting membrane for an electrochemical device, the membrane comprising a layer of a material comprising a ceramic wherein the ceramic comprises boron carbide (B4C).

2. The ion-conducting membrane of claim 1, wherein the material comprises:
60% to 95% by weight of pulverulent ceramic comprising boron carbide, and
5% to 40% by weight of a polymer binder.

3. The ion-conducting membrane of claim 2, wherein the pulverulent ceramic comprises:
boron carbide, or
a mixture of boron carbide and boron nitride comprising an amount of boron carbide greater by weight than the amount of boron nitride.

4. The ion-conducting membrane of claim 2, wherein the polymer binder is:
a polymer of a polytetrafluoroethylene (PTFE) type, or
a polymer of a polyethersulfone type (PES), or
a polymer of a polyethersulfone derivative type, or
a mixture of polytetrafluoroethylene (PTFE), polyethersulfone (PES) and/or a polyethersulfone derivative.

5. The ion-conducting membrane of claim 4, wherein the polymer binder is a polymer of the polytetrafluoroethylene (PTFE) type, in an amount of between 5% and 25% by weight.

6. The ion-conducting membrane of claim 4, wherein the polymer binder is a polymer of the polyethersulfone (PES) type, of the polyethersulfone derivative type, or a polymer mixture comprising the polytetrafluoroethylene (PTFE), the polyethersulfone (PES) and/or the polyethersulfone derivative, the polymer binder being in an amount of between 15% and 40%.

7. A process for producing the ion-conducting membrane of claim 1, the process comprising:
activating by dispersing an amount of ceramic powder in a basic solution, the ceramic powder comprising boron carbide,
adding to the solution a polymer binder to obtain a mixture, and
shaping the mixture.

8. The process of claim 7, wherein the process is suited for a mixture comprising polyethersulfone (PES) or a polyethersulfone derivative, wherein the shaping comprises casting the mixture onto a support and drying.

9. The process of claim 8, wherein, in the shaping, the casting is preceded by adding a solvent.

10. The process of claim 7, wherein the process is suited for a mixture comprising polytetrafluoroethylene (PTFE), wherein the shaping comprises at least one lamination act comprising a rolling act and a folding act carried out successively.

11. The process of claim 10, wherein, in the shaping, the at least one lamination act is preceded by a filtering act and/or a drying act so as to obtain a paste.

12. The process of claim 11, further comprising a final act of rolling of the paste.

13. A cell for an electrochemical device, the cell comprising:
an anode,
a cathode, and
between the anode and the cathode, the ion-conducting membrane as claimed in claim 1.

14. A water electrolysis plant comprising the at least one cell as claimed in claim 13.

15. The ion-conducting membrane of claim 4, wherein the polymer binder is the polymer of the polyethersulfone derivation type, the polyethersulfone derivation type being:
a sulfonated polyethersulfone (SPES), or
an aminated-chlorinated polyethersulfone (PES-Cl-NH2).

16. The ion-conducting membrane of claim 6, wherein the polymer binder is the polymer of the polyethersulfone derivation type, the polyethersulfone derivation type being:
a sulfonated polyethersulfone (SPES), or
an aminated-chlorinated polyethersulfone (PES-Cl-NH2).

17. The process of claim 7, wherein activating by dispersing the amount of ceramic powder in the basic solution comprises activating by dispersing the amount of ceramic powder in a solution of potassium hydroxide.

18. The process of claim 8, wherein casting the mixture onto the support comprises casting the mixture onto a glass plate.
